(19) United States
(12) Patent Application Publication
(10) Pub. No.: US 2017/0353714 A1
(43) Pub. Date: Dec. 7, 2017

(54) SELF-CALIBRATING DISPLAY SYSTEM

(71) Applicants: Navid Poulad, Sunnyvale, CA (US); Roy J. Riccomini, Saratoga, CA (US); Andriy Pletenetskyy, Mountain View, CA (US); Michael Beerman, Mill Valley, CA (US); Jason Paul Williams, Santa Clara, CA (US); Joseph R. Duggan, Berkeley, CA (US)

(72) Inventors: Navid Poulad, Sunnyvale, CA (US); Roy J. Riccomini, Saratoga, CA (US); Andriy Pletenetskyy, Mountain View, CA (US); Michael Beerman, Mill Valley, CA (US); Jason Paul Williams, Santa Clara, CA (US); Joseph R. Duggan, Berkeley, CA (US)

(21) Appl. No.: 15/174,818

(22) Filed: Jun. 6, 2016

(51) Int. Cl. H04N 13/04; H04N 13/00

(52) U.S. Cl. CPC H04N 13/0425; H04N 13/0484; H04N 13/0022; H04N 13/0033; H04N 13/044

(57) ABSTRACT

A self-calibrating display system includes a stereoscopic, near-eye display device, a docking unit, and one or more cameras. The display device includes one or more coupling structures, in addition to one or more microprojectors configured to project a right calibration image and a left calibration image. The docking unit includes one or more complementary coupling structures, each being releasably lockable to a coupling structure of the display device, to prevent movement of the display device relative to the docking unit. The one or more cameras are configured to acquire a secondary image of the right calibration image and a secondary image of the left calibration image.

### BACKGROUND

In recent years, three-dimensional (3D) display technology has undergone rapid development, particularly in the consumer market. High-resolution 3D glasses and visors are now available to the consumer. Using state-of-the-art microprojection technology to project stereoscopically related images to the right and left eyes, these display systems immerse the user in a convincing virtual reality. Nevertheless, certain challenges remain for 3D display systems marketed for consumers. One issue is the discomfort a user may experience due to misalignment of the display system relative to the user's eyes.

### SUMMARY

One embodiment is directed to a self-calibrating display system. The display system includes a stereoscopic, near-eye display device, a docking unit, and one or more cameras. The display device includes one or more coupling structures, in addition to one or more microprojectors configured to project a right calibration image and a left calibration image. The docking unit includes one or more complementary coupling structures, each being releasably lockable to a coupling structure of the display device, to prevent movement of the display device relative to the docking unit. The one or more cameras are configured to acquire a secondary image of the right calibration image and a secondary image of the left calibration image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of an example self-calibrating display system including a stereoscopic, near-eye display device and a docking unit.

FIG. 2 shows aspects of an example microprojector, eye-imaging camera, and display window of a display device.

FIGS. 3 and 4 illustrate stereoscopic display of a virtual object according to an embodiment of this disclosure.

FIG. 5 shows additional aspects of the example docking unit of FIG. 1.

FIG. 6 illustrates an example autocalibration method to be enacted in a self-calibrating display system.

FIG. 7 is a graph of a disparity correction plotted as a function of display-device temperature.

### DETAILED DESCRIPTION

Aspects of this disclosure will now be described by example and with reference to the drawing figures listed above. Components, process steps, and other elements that may be substantially the same in one or more embodiments are identified coordinately and described with minimal repetition. It will be noted, however, that elements identified coordinately may also differ to some degree. It will be further noted that the drawing figures are schematic and generally not drawn to scale. Rather, the various drawing scales, aspect ratios, and numbers of components shown in the figures may be purposely distorted to make certain features or relationships easier to see.

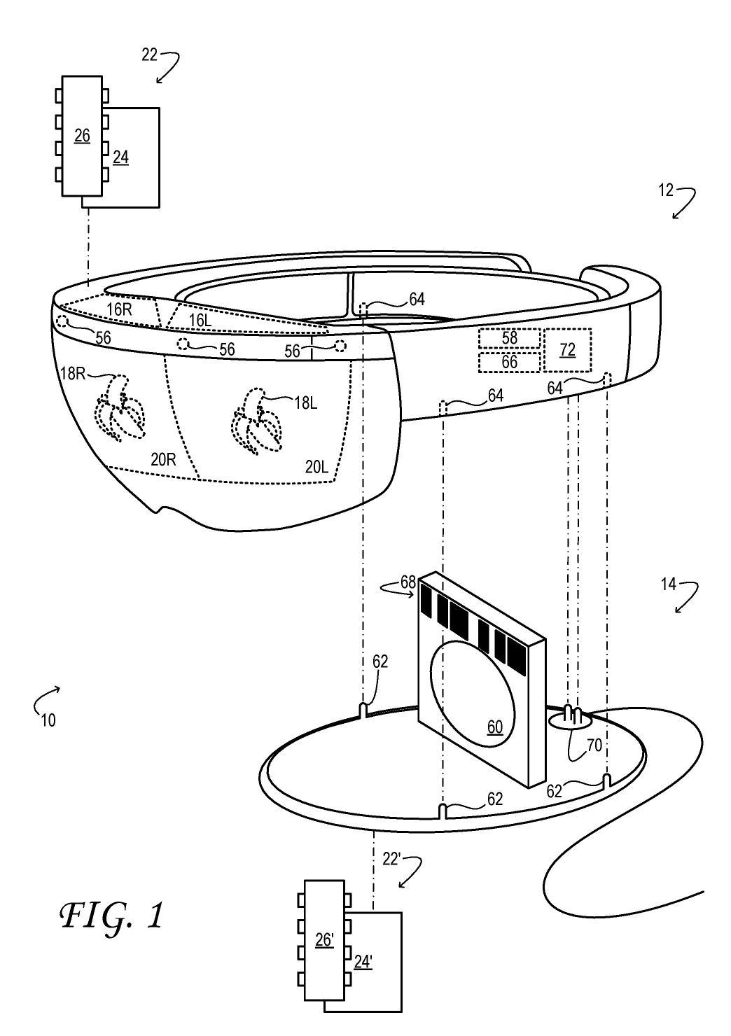

FIG. 1 shows aspects of an example self-calibrating display system 10. The display system includes a stereoscopic, near-eye display device 12 and a docking unit 14.

Display device 12 includes a right microprojector 16R configured to project a right image 18R and a left microprojector 16L configured to project a left image 18L. In typical use, each of the right and left images is a display image. Viewed binocularly by a user of the display device, the right and left images are fusable in the user's visual cortex to effect stereoscopic, 3D image display. During calibration of the display device, each of the right and left images takes the form of a calibration image, as described further below. Although separate right and left microprojectors are shown in FIG. 1, a single microprojector, alternatively, may be used to form the right and left images.

Display device 12 includes a right display window 20R and a left display window 20L. In some embodiments, the right and left display windows 20 are at least partially transparent from the perspective of the user, to give the user a clear view of his or her surroundings. This feature enables virtual display imagery to be admixed with real imagery from the surroundings, for an illusion of ‘augmented’ or ‘mixed’ reality. In other embodiments, the display windows are opaque, so as to provide a fully immersive ‘virtual’ reality experience.

Logic system 22 is operatively coupled to various electronic components of display device 12. The logic system is configured, inter alia, to control microprojectors 16 and to enact autocalibration of the display device, as described herein. To these ends, the logic system may include one or more processors 24 and associated electronic memory 26. In some embodiments, display imagery is received in real time from an external network via logic system 22, and conveyed to microprojectors 16. The display imagery may be transmitted in any suitable form—viz., type of transmission signal and data structure. The signal encoding the display imagery may be carried over a wired or wireless communication link to the logic system. In other embodiments, at least some display-image composition and processing may be enacted from within the logic system itself. Additional aspects of logic system 22 are described further below.

When display device 12 is in use, logic system 22 sends appropriate control signals to right microprojector 16R which cause the right microprojector to form right image 18R in right display window 20R. Likewise, the logic system sends appropriate control signals to left microprojector 16L which cause the left microprojector to form left image 18L in left display window 20L. The display-device user views the right and left images through the right and left eyes, respectively. When the right and left images are composed and presented in an appropriate manner (vide infra), the user experiences the illusion of one or more virtual objects at specified positions, having specified 3D content and other display properties. A plurality of virtual objects of any desired complexity may be displayed concurrently in this manner, so as to present a complete virtual scene having foreground and background portions.

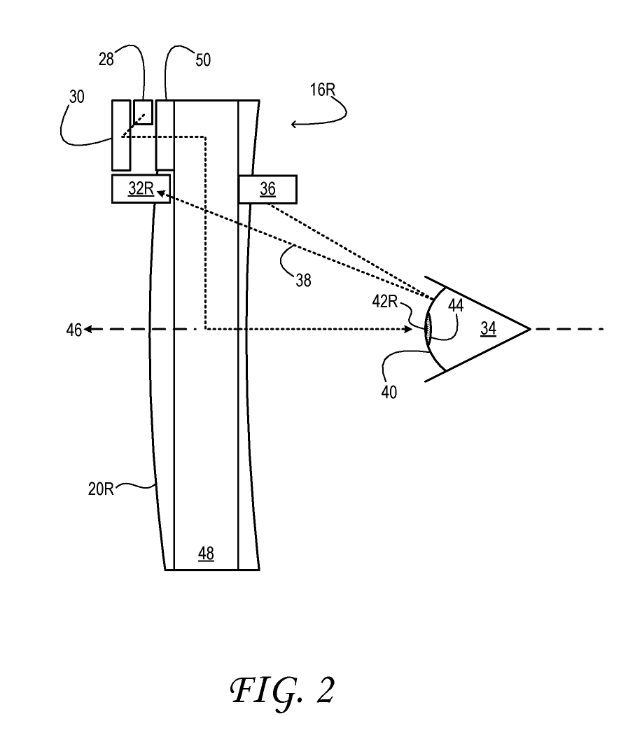

FIG. 2 shows aspects of right microprojector 16R and associated display window 20R in one, non-limiting embodiment. The microprojector includes a light source 28 and a liquid-crystal-on-silicon (LCOS) array 30. The light source may include an ensemble of light-emitting diodes (LEDs)—e.g., white LEDs or a distribution of red, green, and blue LEDs. The light source may be situated to direct its emission onto the LCOS array, which is configured to form a display image based on the control signals from logic system 22. The LCOS array may include numerous, individually addressable pixels arranged on a rectangular grid or other geometry. In some embodiments, pixels reflecting red light may be juxtaposed in the array to pixels reflecting green and blue light, so that the LCOS array forms a color image. In other embodiments, a digital micromirror array may be used in lieu of the LCOS array, or an active-matrix LED array may be used instead. In still other embodiments, transmissive, backlit LCD or scanned-beam technology may be used to form the display image.

FIG. 2 also shows right eye-imaging camera 32R. The right eye-imaging camera is configured to sense a position of the right eye 34 of the user of display device 12. In the embodiment of FIG. 2, the right eye-imaging camera images light from eye lamp 36 reflected off the user's right eye. The eye lamp may include an infrared or near-infrared LED configured to illuminate the eye. In one embodiment, the eye lamp may provide relatively narrow-angle illumination, to create a specular glint 38 on the cornea 40 of the eye. The right eye-imaging camera is configured to image light in the emission-wavelength range of the eye lamp. This camera may be arranged and otherwise configured to capture light from the eye lamp, which is reflected from the eye. Image data from the camera is conveyed to associated logic in logic system 22. There, the image data may be processed to resolve such features as right pupil center 42R, pupil outline 44, and/or one or more specular glints 38 from the cornea. The locations of such features in the image data may be used as input parameters in a model—e.g., a polynomial model—that relates feature position to the gaze vector 46 of the eye. In some embodiments, the model may be precalibrated during set-up of display device 12—e.g., by drawing the user's gaze to a moving target or to a plurality of fixed targets distributed across the user's field of view, while recording the image data and evaluating the input parameters. The user's gaze vector may be used in various ways in display-device applications. For example, it may be used to determine where and at what distance to display a notification or other virtual object that the user can resolve without changing his or her current focal point.

In some embodiments, the display image from LCD array 30 may not be suitable for direct viewing by the user of display device 12. In particular, the display image may be offset from the user's eye, may have an undesirable vergence, and/or a very small exit pupil (i.e., area of release of display light, not to be confused with the user's anatomical pupil). In view of these issues, the display image from the LCD array may be further conditioned en route to the user's eye, as described below.

In the embodiment of FIG. 2, the display image from LCD array 30 is received into a vertical pupil expander 48. The vertical pupil expander lowers the display image into the user's field of view, and in doing so, expands the exit pupil of the display image in the ‘vertical’ direction. In this context, the vertical direction is the direction orthogonal to the user's interocular axis and to the direction that the user is facing. From vertical pupil expander 48, the right image is received into a horizontal pupil expander, which may be coupled into or embodied as right display window 20R. In other embodiments, the horizontal pupil expander may be distinct from the right display window. The horizontal pupil expander expands the exit pupil of the display image in the ‘horizontal’ direction. The horizontal direction, in this context, is the direction parallel to the interocular axis of the user of display device 12—i.e., the direction in and out of the page in FIG. 2. By passing through the horizontal and vertical pupil expanders, the display image is presented over an area that covers the eye. This enables the user to see the display image over a suitable range of horizontal and vertical offsets between the microprojector and the eye. In practice, this range of offsets may reflect factors such as variability in anatomical eye position among users, manufacturing tolerance and material flexibility in display device 12, and imprecise positioning of the display device on the user's head.

In some embodiments, right microprojector 16R may apply optical power to the display image from LCD array 30, in order to adjust the vergence of the display image. Such optical power may be provided by the vertical and/or horizontal pupil expanders, or by lens 50, which couples the display image from the LCD array into the vertical pupil expander. If light rays emerge convergent or divergent from the LCD array, for example, the microprojector may reverse the image vergence so that the light rays are received collimated into the user's eye. This tactic can be used to form a display image of a far-away virtual object. Alternatively, the microprojector may be configured to impart a fixed or adjustable divergence to the display image, consistent with a virtual object positioned a finite distance in front of the user. Naturally, the foregoing description of right microprojector 16R, right display window 20R, and right eye-imaging camera 32R applies equally to left microprojector 16L, left display window 20L, left eye-imaging camera 32L, and left pupil center 42L.

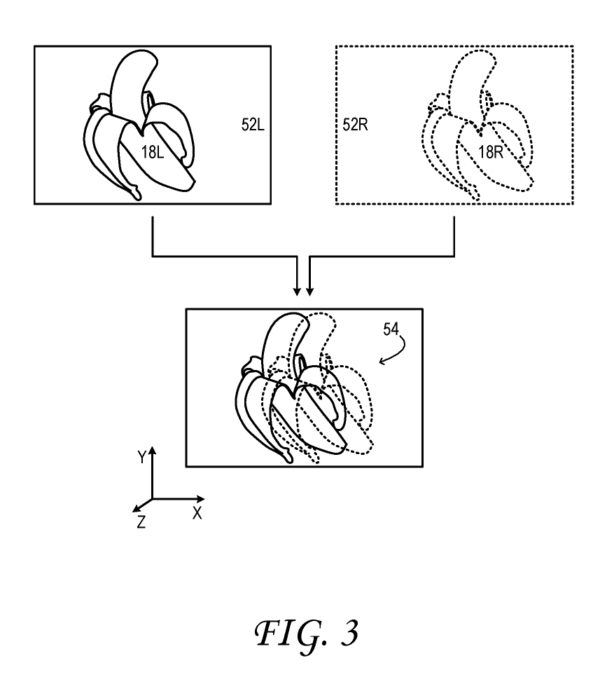

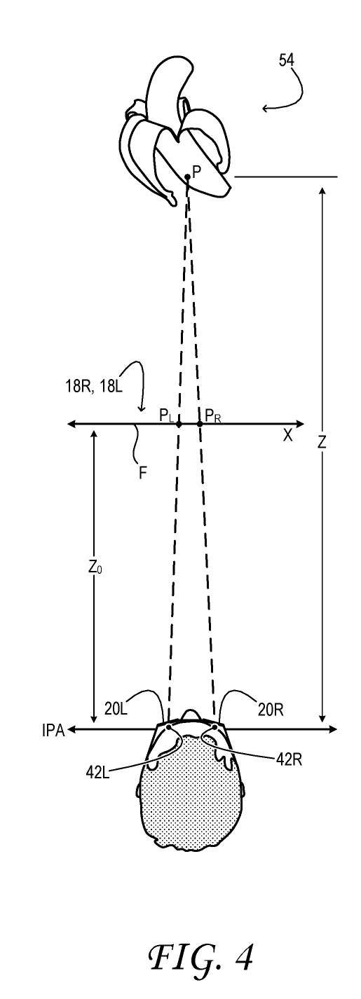

Continuing, a user's perception of distance to a given locus of a virtual display object is affected not only by display-image vergence but also by positional disparity between the right and left display images. This principle is illustrated by way of example in FIGS. 3 and 4. FIG. 3 shows right and left image frames 52R and 52L, overlaid upon each other for purposes of illustration. The right and left image frames correspond to the image-forming areas of LCD arrays 30 of right and left microprojectors 16R and 16L. As such, the right image frame encloses right display image 18R, and the left image frame encloses left display image 18L. Rendered appropriately, the right and left display images may appear to the user as a virtual 3D object 54 of any desired complexity. In the example of FIG. 3, the virtual object includes a surface contour having a depth coordinate Z associated with each pixel position (X, Y) of the right and left image frames. The desired depth coordinate may be simulated in the following manner, with reference now to FIG. 4.

Right and left microprojectors 16 may be configured to project each locus P of right and left images 18 onto focal a plane F located a fixed distance Z₀ from the interpupilary axis (IPA) of the user. Z₀ is a function of the vergence applied by the microprojectors. In one embodiment, Z₀ may be set to ‘infinity’, so that each microprojector presents a display image in the form of collimated light rays. In another embodiment, Z₀ may be set to two meters, requiring each microprojector to present the display image in the form of diverging rays. In some embodiments, Z₀ may be chosen at design time and remain unchanged for all virtual objects rendered by display device 12.

In other embodiments, each microprojector may be configured with electronically adjustable optical power, allowing Z₀ to vary dynamically according to the range of distances over which virtual display object 54 is to be presented.

Once the distance Z₀ to focal plane F has been established, the depth coordinate Z for every surface point P of virtual object 54 may be determined. This is done by adjusting the positional disparity of the two loci corresponding to point P in the right and left display images, relative to their respective image frames 52L and 52R. In FIG. 4, the locus corresponding to point P in the right image frame is denoted P_{R}, and the corresponding locus in the left image frame is denoted P_{L}. In FIG. 4, the positional disparity is positive—i.e., P_{R} is to the right of P_{L} in the overlaid image frames. This causes point P to appear behind focal plane F. If the positional disparity were negative, P would appear in front of the focal plane. Finally, if the right and left display images were superposed (no disparity, P_{R} and P_{L} coincident) then P would appear to lie directly on the focal plane. Without tying this disclosure to any particular theory, the positional disparity D may be related to Z, Z₀, and to the interpupilary distance (IPD) by

$$D = I P D \times ( 1 - \frac{{Z}_{0}}{Z} ) .$$

In the approach described above, the positional disparity sought to be introduced between corresponding loci of the right and left display images 18 is parallel to the interpupilary axis of the user of display device 12. Here and elsewhere, positional disparity in this direction is called ‘horizontal disparity,’ irrespective of the orientation of the user's eyes or head. Introduction of horizontal disparity is appropriate for virtual object display because it mimics the effect of real-object depth on the human visual system, where images of a real object received in the right and left eyes are naturally offset along the interpupilary axis. If a user chooses to focus on such an object, and if the object is closer than infinity, then the eye muscles will tend to rotate each eye about its vertical axis, to image that object onto the fovea of each eye, where visual acuity is greatest.

In contrast, vertical disparity between the left and right display images is uncommon in the natural world and unuseful for stereoscopic display. ‘Vertical disparity’ is the type of positional disparity in which corresponding loci of the right and left display images are offset in the vertical direction—viz., perpendicular to the IPA and to the direction that the user is facing. Although the eye musculature can rotate the eyes up or down to image objects above or below a user's head, this type of adjustment invariably is done on both eyes together. The eyes have quite limited ability to move one eye up or down independent of the other, so when presented with an image pair having vertical disparity, eye fatigue and/or headache results, as the eye muscles strain to bring each image into focus.

Based on the description provided herein, the skilled reader will understand that imperfect vertical alignment of right microprojector 16R relative to left microprojector 16L is apt to introduce a component of vertical disparity between the right and left display images. Such is the case for any stereo display. Misalignment may also occur due to imprecise positioning of the display device on the user's face, or strabismus, where at least one pupil may adopt an unexpected position, effectively tilting the ‘horizontal’ direction relative to the user's face. Imperfect horizontal alignment of the right and left microprojectors results in virtual display objects being shifted away from their intended depth. The term ‘decalibration’ refers herein to spontaneous horizontal as well as vertical misalignment, whether the transition to the decalibrated state is gradual or abrupt. Right eye-imaging camera 32R and left eye-imaging camera 32L are also subject to decalibration, resulting in inaccurate gaze tracking.

Temperature change in display device 12 is believed to contribute to alignment decalibration of microprojectors 16 and of eye-imaging cameras 32. The temperature of display device 12, and of localized portions thereof, may vary significantly during use. Logic-intensive operations and high backlight settings, for example, dissipate increased power and cause increased heating. The heating, in turn, causes thermal stress on various display-device components, which may expand at different rates. Thermal stress results in dimensional changes, which may affect display projector and/or eye-imaging camera alignment. In view of the foregoing analysis, it may be desirable for autocalibration of display device 12 to be enacted as a function of temperatures measured at different points on the display device. In FIG. 1, accordingly, a plurality of temperature sensors 56 are schematically depicted within the display device, to monitor the operating temperature of the various components of the display device. Any number of temperature sensors may be used in any location.

Mechanical shock to display device 12 is believed to contribute to alignment decalibration of microprojectors 16 and of eye-imaging cameras 32. It is desirable, therefore, for autocalibration of the display device to be scheduled so as to follow any mechanical shock that may be detected. In FIG. 1, accordingly, an inertial measurement unit 58 configured to sense mechanical shock is schematically depicted in the display device. The inertial measurement unit may comprise an accelerometer and/or gyroscope, for example.

The problem of microprojector alignment decalibration may be addressed during use of display device 12, by leveraging the eye-tracking functionality built into the display device. In particular, each eye-imaging camera 32 may be configured to assess a pupil position of the associated eye relative to a frame of reference fixed to the display system. With the pupil position in hand, the display system may be configured to shift and scale the display images by an appropriate amount to cancel any vertical component of the positional disparity, and to ensure that the remaining horizontal disparity is of an amount to place the rendered virtual object at the specified distance in front of the user.

The approach outlined above admits of many variants and equally many algorithms to enact the required shifting and scaling. In one embodiment, logic system 22 maintains a model of the Cartesian space in front of the user in a frame of reference fixed to display device 12. The user's pupil positions, as determined by the eye-imaging cameras, are mapped onto this space, as are the superimposed image frames 52R and 52L, which are positioned at the predetermined depth Z₀. (The reader is again directed to FIGS. 3 and 4.) Then, a virtual object 54 is constructed, with each point P on a viewable surface of the object having coordinates X, Y, and Z, in the frame of reference of the display system. For each point on the viewable surface, two line segments are constructed-a first line segment to the pupil position of the user's right eye and a second line segment to the pupil position of the user's left eye. The locus P_{R} of the right display image, which corresponds to point P, is taken to be the intersection of the first line segment in right image frame 52R. Likewise, the locus P_{L} of the left display image is taken to be the intersection of the second line segment in left image frame 52L. This algorithm automatically provides the appropriate amount of shifting and scaling to eliminate the vertical disparity and to create the right amount of horizontal disparity to correctly render the viewable surface of the virtual object, placing every point P at the required distance from the user. In some embodiments, the required shifting and scaling may be done in the frame buffers of one or more graphics-processing units (GPUs) of logic system 22, which accumulate the right and left display images. In other embodiments, electronically adjustable optics in microprojectors 16 may be used to shift and/or scale the display images by the appropriate amount.

Despite the benefits of autocalibrating microprojectors 16 during use, it may not be desirable, in general, to shift and scale the display images to track pupil position in real time. In the first place, it is to be expected that the user's eyes will make rapid shifting movements, with ocular focus shifting off the display content for brief or even prolonged periods. It may be distracting or unwelcome for the display imagery to constantly track these shifts. Further, there may be noise associated with the determination of pupil position. It could be distracting for the display imagery to shift around in response to such noise. Moreover, it would require higher resolution for the eye-imaging cameras than might otherwise be necessary merely for purposes of gaze tracking. Finally, accurate, moment-to-moment eye tracking with real-time adjustment of the display imagery may require more compute power than is affordable in a consumer device.

Instead of or in addition to enacting autocalibration while display device 12 is in use, intermittent autocalibration during periods of disuse may be sufficient to maintain display fidelity, prevent user eyestrain, etc. It may be further desirable to perform the intermittent autocalibration when the display device is linked to a docking unit-recharging, for example—or being stored in a carrying case. Docking unit 14 is configured, accordingly, to support intermittent autocalibration.

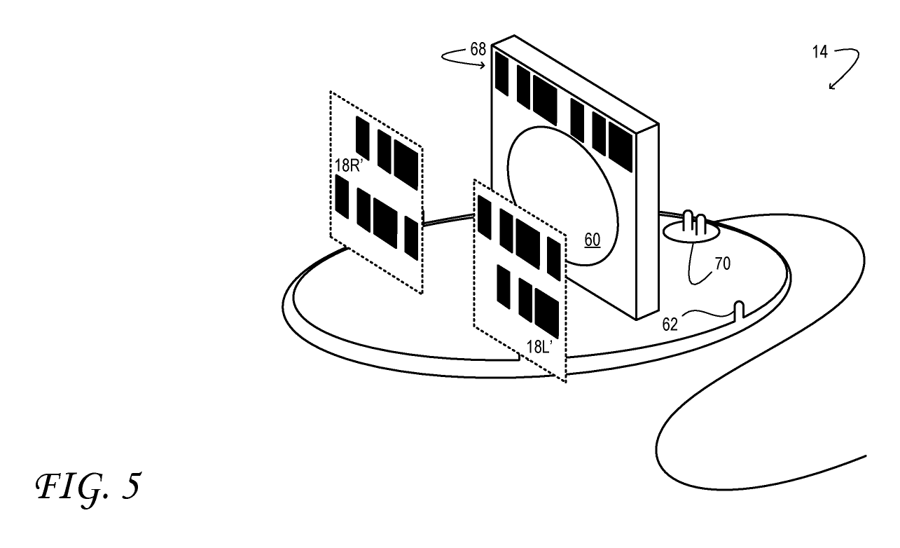

Turning now to FIG. 5, during autocalibration, display device 12 projects right and left calibration images 18R′ and 18L′ to docking unit 14. It is to be understood that the calibration images are projected by the display device (e.g., display device 12 of FIG. 1), even though the display device is not shown in FIG. 5. The calibration images may include one or more blocks, lines, and/or dots in predetermined positions, or any other suitable image useable to detect positional disparity and/or assess defects in display-image quality. The docking unit is configured to receive the right and left calibration images from the display device and to send secondary images of the right and left calibration images back to the display device. The secondary images of the calibration images are processed in display-system logic to compute disparity corrections to be used by microprojectors 16 during subsequent projection of right and left display images. The disparity corrections are such that each pixel of the right display image and an associated pixel of the left display image are projected with reduced vertical disparity, and with sufficient horizontal disparity to render a stereoscopically fused display locus at a predetermined depth. The specific values of the disparity corrections may be such as to enforce the geometric relationships between the depth coordinate Z and the right and left pixel positions P_{R} and P_{L}, as described above with reference to FIGS. 3 and 4.

To send the secondary images of the right and left calibration images back to display device 12, docking unit 14 includes a secondary image sender 60, which is held in fixed registry to the display device via mechanical or magnetic coupling. In the embodiment of FIG. 1, the docking unit includes three registration pins 62; the display device includes three depressions 64 configured to receive the registration pins. More generally, a display device consonant with this disclosure may include one or more coupling structures of any kind, and the docking unit may have one or more complementary coupling structures. Each complementary coupling structure of the docking unit is releasably lockable to a corresponding coupling structure of the display device, to prevent (i.e., discourage) unwanted movement of the display device relative to the docking unit when the display device is coupled to the docking unit. In other examples, registration pins 62 may be arranged on the display device, and depressions 64 may be arranged on the docking unit. In still other examples, each coupling structure of the display device may include a small permanent magnet, and each complementary coupling structure may include another small permanent magnet or small ferromagnetic object, or vice versa.

Secondary image sender 60 is configured to send display device 12 a secondary image of a right calibration image and a secondary image of a left calibration image, the right and left calibration images being received from the display device during calibration. Secondary image receiver 66 of the display device is configured to receive, from the docking unit, the secondary image of the right calibration image and the secondary image of the left calibration image. In some examples, the secondary image sender includes one or more digital cameras fixedly coupled to the docking unit. In the example of FIG. 5, a single camera of the secondary image sender is used to sight both the right and left calibration images. This configuration ensures that the secondary images will remain perfectly registered with respect to each other. However, separate right and left cameras are also envisaged.

When secondary image sender 60 is a digital camera, the secondary image of the right calibration image and the secondary image of the left calibration image are encoded in image data. Accordingly, secondary image receiver 66 of display device 12 may be any wired or wireless data link configured to receive the image data-USB, Bluetooth, etc. In other embodiments, however, the secondary image sender may be a mirror that simply reflects the right and left calibration images into the secondary image receiver of the display device, which may include one or more cameras, such as eye-imaging cameras 32. In other words, the secondary image of the right calibration image may be an optical reflection of the right calibration image, and the secondary image of the left calibration image may be an optical reflection of the left calibration image. In both examples, display system 10 (the display device and docking unit taken as a whole) includes one or more cameras configured to acquire a secondary image of the right calibration image and a secondary image of the left calibration image, whether such cameras are arranged in the display device or in the docking unit.

In some implementations, autocalibration of the one or more eye-imaging cameras 32 of display device 12 is also desired. To this end, docking unit 14 includes a calibration pattern 68 visible to the eye-imaging cameras when the display device is coupled to the docking unit. Display-system logic may be configured, during calibration, to command the eye-imaging cameras to acquire an image of the calibration pattern while the display device is docked to the docking unit. Based on the disparities of the calibration images acquired by the right and left eye-imaging cameras, a calibration offset or other transform may be applied to improve the binocular alignment of the eye-imaging cameras.

Docking unit 14 also includes a charger 70 configured to charge battery 72 of display device 12, drawing power from a wall outlet. In embodiments in which the docking unit is integrated into a carrying case, power may be supplied from an external battery installed in the carrying case. The charging feature is advantageous in some configurations, but is not strictly necessary. In carrying-case embodiments, the docking unit may include an enclosure (not shown in the drawings) configured to enclose the display device during transport. Certain other variations are envisaged for docking units integrated into a carrying case. For instance, the coupling structures of the display device and the complementary coupling structures of the docking unit may be configured to lock more positively when overall motion of the docked display system is a possibility. In some embodiments, therefore, each coupling structure may include a screw threads rotated via thumbwheel, or similar positive coupling mode.

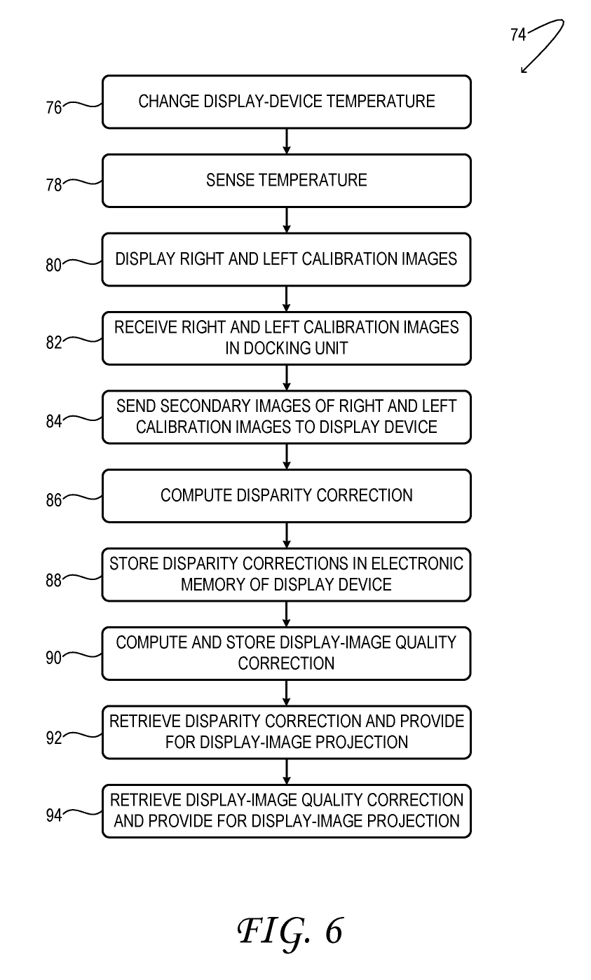

FIG. 6 illustrates an example autocalibration method 74 to be enacted in display system 10. At 76 of method 74, the display-system logic causes a change in a temperature of display device 12. The temperature change may be brought about by a change in the rate of power dissipation of logic system 22 of the display device. For example, certain logic subsystems and/or processes may be powered up to effect an increase in the temperature, or powered down to effect a decrease in the temperature. At 78 the temperature is sensed at one or more localities of the display device via the one or more temperature sensors 56. In some implementations, temperature changing at 76 and temperature sensing at 78 may be enacted in a closed-loop manner, so as to transition the display device controllably through a series of predetermined setpoint temperatures. In other implementations, the temperature change may be open-loop and may vary in response to environmental conditions.

At 80 of method 74, the display-system logic causes the one or more microprojectors 16 to display the right and left calibration images. At 82 the right and left calibration images are received in docking unit 14. At 84 the secondary image sender of the docking unit sends a secondary image of the right calibration image and a secondary image of the left calibration image back to display device 12. As described hereinabove, the secondary images may be received as electronic image data in some embodiments; in other embodiments, the secondary images may be optical reflections received in eye-imaging cameras 32 of the display device.

At 86 of method 74, the display-system logic computes a disparity correction based on the secondary image of the right calibration image and the secondary image of the left calibration image. The disparity correction is used by the one or more microprojectors 16 during subsequent projection of right and left display images. The disparity correction is such that each pixel of the right display image and an associated pixel of the left display image are projected with reduced vertical disparity, and with sufficient horizontal disparity to render a stereoscopically fused display locus at a predetermined depth. In some examples, the disparity correction may include a vertical disparity correction and a horizontal disparity correction. Each of the vertical and horizontal disparity corrections may take the form of an offset applied to user-specified disparity setpoints. An appropriate user-specified vertical disparity setpoint could be the elevation difference of the user's eyes in the frame of reference of the display device as worn; an appropriate user-specified horizontal disparity setpoint could be the user's interocular or average interpupilary distance, for example. In some examples, each of the vertical and horizontal disparity corrections may include a translation operation—e.g., shift the locus N pixels down or to the right. In some examples, each of the vertical and horizontal disparity corrections may also include a scaling operation. In some examples, the overall effect of the shifting and scaling is to enforce the geometric relationships between the depth coordinate Z and the right and left pixel positions P_{R} and P_{L}, as described above with reference to FIGS. 3 and 4. The functional difference is that instead of the afore-referenced right and left line segments originating at their respective pupil positions 42R and 42L, the line segments may originate at predetermined virtual pupil positions in the field of view of secondary image sender 60 of docking unit 14.

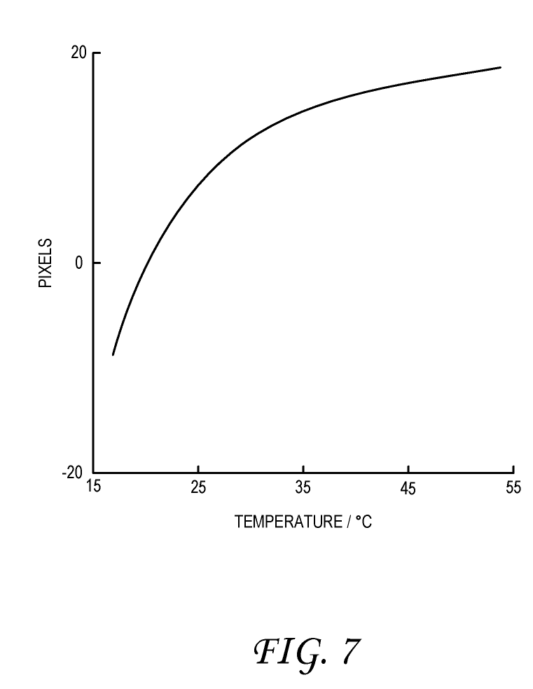

In some embodiments, disparity and other corrections may be applied as functions of the one or more temperatures sensed at 78 of method 74. FIG. 7 shows an example graph of a single disparity correction C as a function of a single, localized temperature T. In embodiments in which two or more disparity or other corrections are computed as functions of temperature sensed at two or more localities of display device 12, the corrections may be expressed as C=MT, where C is a vector of corrections CQ, T is a vector of temperatures Ti, and M is the coefficient matrix that provides the best fit to the data.

Returning, now, to FIG. 6, at 88 of method 74, the display-system logic stores the one or more disparity corrections in electronic memory of display device 12. The disparity corrections may be stored in the form of a table, a coefficient matrix, etc. In embodiments in which the disparity correction and/or the display-image quality correction is computed at a plurality of different temperatures, the logic to compute the disparity correction is configured to storably associate such corrections with output of the one or more temperature sensors, for each of a plurality of temperatures of the display device.

At 90 the display-system logic computes and stores, in electronic memory of display device 12, a display-image quality correction based on the secondary image of the right calibration image and the secondary image of the left calibration image. Like the disparity correction discussed above, the display-image quality correction is used during the subsequent projection of the right and left display images. The display-image quality correction is used to correct for display-image non-uniformity, e.g., color banding. For example, if a calibration image is supposed to have a white background, but the associated secondary image reveals a pink hue at the top and a blue hue at the bottom, then a display-image quality correction may be computed that, if applied to the calibration image, would make the background uniformly white. Like the disparity correction discussed above, the display-image quality correction may be computed and stored as a function of one or more local temperatures of the display device.

At 92 logic of the display device retrieves the disparity correction and provides the disparity correction to the one or more microprojectors 16 for subsequent projection of right and left display images. In some examples, the logic to retrieve the disparity correction is configured to interpolate between the stored disparity corrections to compute an interpolated disparity correction. At 94 logic of the display device retrieves the display-image quality correction and provides the display-image quality correction to the one or more projectors for subsequent correction of the right and left display images.

No aspect of FIG. 6 should be interpreted in a limiting sense, for numerous variations, extensions, and omissions are envisaged. For instance, the temperature dependence of the disparity and/or display-image quality correction need not be evaluated in every implementation. In some examples, the display-system logic may compute a temperature-agnostic disparity correction. In some examples, the temperature-agnostic correction may be adequate to us as-is. In other examples, a temperature-dependent correction may be estimated at runtime according to a model.

Input to the model may include a temperature-agnostic correction derived from intermittent autocalibration during disuse, and one or more temperatures sensed at runtime, or predicted based on processor load, power dissipation, etc.

In some embodiments, method 74 may run on a schedule. The display-system logic may schedule computation of the disparity correction responsive to output from inertial measurement unit 58 consistent with mechanical shock to display device 12. In other words, recalibration may be scheduled for a docking interval following a usage interval in which the display device was dropped or thrown. In other examples, recalibration may be scheduled every time the display device is docked, every N^{th} time, etc. In some embodiments, disparity corrections for eye-imaging cameras 32R and 32L may be computed in method 74, based on the imaging of calibration pattern 68 when the display system is docked. Such corrections, in addition to the afore-mentioned disparity and display-image quality corrections may be stored in electronic memory of the display device, and retrieved and applied during subsequent eye imaging.

In some embodiments, the methods and processes described herein may be tied to a logic system of one or more logic (e.g., computing) devices. In particular, such methods and processes may be implemented as a computer-application program or service, an application-programming interface (API), a library, and/or other computer-program product.

FIG. 1 schematically shows a non-limiting embodiment of a logic system 22 of display device 12 that can enact one or more of the methods and processes described above. Docking unit 14 includes an analogous logic system 22′.

Logic system 22 includes a processor 24 and an electronic memory machine 26. Logic system 22 may be operatively coupled to a display subsystem, input subsystem, communication subsystem, and/or other components not shown in FIG. 1. Logic system 22′ includes a processor 24′ and electronic memory machine 26′.

Processor 24 includes one or more physical devices configured to execute instructions. For example, the processor may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Processor 24 may be one of a plurality of processors configured to execute software instructions. Additionally or alternatively, the processor may include one or more hardware or firmware logic machines configured to execute hardware or firmware instructions. Processors of logic system 22 may be single-core or multi-core, and the instructions executed thereon may be configured for sequential, parallel, and/or distributed processing. Individual components of the logic system optionally may be distributed among two or more separate devices, which may be remotely located and/or configured for coordinated processing. Aspects of the logic system may be virtualized and executed by remotely accessible, networked computing devices configured in a cloud-computing configuration.

Electronic memory machine 26 includes one or more physical devices configured to hold instructions executable by processor 24 to implement the methods and processes described herein. When such methods and processes are implemented, the state of electronic memory machine 26 may be transformed—e.g., to hold different data.

Electronic memory machine 26 may include removable and/or built-in devices. Electronic memory machine 26 may include semiconductor memory (e.g., RAM, EPROM, EEPROM, etc.), and/or magnetic memory (e.g., hard-disk drive, floppy-disk drive, tape drive, MRAM, etc.), among others. Electronic memory machine 26 may include volatile, nonvolatile, dynamic, static, read/write, read-only, random-access, sequential-access, location-addressable, file-addressable, and/or content-addressable devices.

It will be appreciated that electronic memory machine 26 includes one or more physical devices. However, aspects of the instructions described herein alternatively may be propagated by a communication medium (e.g., an electromagnetic signal, an optical signal, etc.) that is not held by a physical device for a finite duration.

Aspects of processor 24 and electronic memory machine 26 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of logic system 22 implemented to perform a particular function. In some cases, a module, program, or engine may be instantiated via processor 24 executing instructions held by electronic memory machine 26. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, a display subsystem may be used to present a visual representation of data held by electronic memory machine 26. This visual representation may take the form of a graphical user interface (GUI). As the herein described methods and processes change the data held by the storage machine, and thus transform the state of the storage machine, the state of the display subsystem may likewise be transformed to visually represent changes in the underlying data. The display subsystem may include one or more display devices utilizing virtually any type of technology. Such display devices may be combined with processor 24 and/or electronic memory machine 26 in a shared enclosure, or such display devices may be peripheral display devices.

When included, an input subsystem may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, a communication subsystem may be configured to communicatively couple logic system 22 with one or more other computing devices. The communication subsystem may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow logic system 22 to send and/or receive messages to and/or from other devices via a network such as the Internet.

One implementation is directed to a self-calibrating display system comprising: a stereoscopic, near-eye display device having one or more coupling structures and having one or more microprojectors configured to project a right calibration image and a left calibration image; a docking unit having one or more complementary coupling structures, each being releasably lockable to a coupling structure of the display device, to prevent movement of the display device relative to the docking unit; and one or more cameras configured to acquire a secondary image of the right calibration image and a secondary image of the left calibration image.

In some implementations, the display system further comprises logic to cause the one or more microprojectors to display the right and left calibration images. In some implementations, the display system further comprises logic to compute a disparity correction based on the secondary image of the right calibration image and the secondary image of the left calibration image, the disparity correction to be used by the one or more microprojectors during subsequent projection of right and left display images, such that each pixel of the right display image and an associated pixel of the left display image are projected with reduced vertical disparity, and with sufficient horizontal disparity to render a stereoscopically fused display locus at a predetermined depth. In some implementations, the display system further comprises one or more temperature sensors arranged in the display device; and logic to cause an increase in a temperature of the display device, wherein the logic to compute the disparity correction is configured to associate the disparity correction with output of the one or more temperature sensors, for each of a plurality of temperatures of the display device.

Another implementation is directed to a stereoscopic, near-eye display device of a self-calibrating display system, the display device comprising: one or more coupling structures, each being releasably lockable to a complementary coupling structure of a docking unit and configured to prevent movement of the display device relative to the docking unit; one or more microprojectors configured to project a right calibration image and a left calibration image; a secondary image receiver configured to receive, from the docking unit, a secondary image of the right calibration image and a secondary image of the left calibration image; logic to store, in electronic memory of the display device, a disparity correction based on the secondary image of the right calibration image and the secondary image of the left calibration image, the disparity correction to be used by the one or more microprojectors during subsequent projection of right and left display images, such that each pixel of the right display image and an associated pixel of the left display image are projected with reduced vertical disparity, and with sufficient horizontal disparity to render a stereoscopically fused display locus at a predetermined depth; and logic to retrieve the disparity correction and provide the disparity correction to the one or more microprojectors for the subsequent projection.

In some implementations, the display device further comprises one or more temperature sensors; and logic to increase a temperature of the display device, wherein the logic to store the disparity correction is configured to storably associate the disparity correction with output of the one or more temperature sensors, for each of a plurality of temperatures of the display device. In some implementations, the disparity correction includes a vertical disparity correction and a horizontal disparity correction. In some implementations, the logic to retrieve the disparity correction is configured to interpolate between the stored disparity corrections to compute an interpolated disparity correction. In some implementations, the one or more coupling structures and the one or more complementary coupling structures include a pin and a depression to receive the pin. In some implementations, the one or more coupling structures and the one or more complementary coupling structures include a magnet. In some implementations, the secondary image of the right calibration image and the secondary image of the left calibration image are encoded in data, and the secondary image receiver is a data link configured to receive the data. In some implementations, the secondary image of the right calibration image is an optical reflection of the right calibration image, wherein the secondary image of the left calibration image is an optical reflection of the left calibration image, and wherein the secondary image receiver includes one or more cameras. In some implementations, the one or more microprojectors include separate right and left microprojectors. In some implementations, the display device further comprises an inertial measurement unit and logic to schedule computation of the disparity correction responsive to output from the inertial measurement unit consistent with mechanical shock to the display device. In some implementations, the display device further comprises logic to store, in the electronic memory of the display device, a display-image quality correction based on the secondary image of the right calibration image and the secondary image of the left calibration image, the display-image quality correction to be used during the subsequent projection of the right and left display images; and logic to retrieve the display-image quality correction.

Another implementation is directed to docking unit of a self-calibrating display system, the docking unit comprising: one or more coupling structures, each being releasably lockable to a complementary coupling structure of a stereoscopic, near-eye display device and configured to prevent movement of the display device relative to the docking unit; and a secondary image sender configured to send the display device a secondary image of a right calibration image and a secondary image of a left calibration image, the right and left calibration images being received from the display device.

In some implementations, the secondary image sender includes one or more cameras. In some implementations, the docking unit further comprises an enclosure configured to enclose the display device during transport. In some implementations, the docking unit further comprises a charger configured to charge a battery of the display device. In some implementations, the docking unit further comprises a calibration pattern visible to one or more eye-imaging cameras of the display device when the display device is coupled to the docking unit.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A self-calibrating display system comprising:
a stereoscopic, near-eye display device having one or more coupling structures and having one or more microprojectors configured to project a right calibration image and a left calibration image;
a docking unit having one or more complementary coupling structures, each being releasably lockable to a coupling structure of the display device, to prevent movement of the display device relative to the docking unit; and
one or more cameras configured to acquire a secondary image of the right calibration image and a secondary image of the left calibration image.

2. The display system of claim 1 further comprising logic to cause the one or more microprojectors to display the right and left calibration images.

3. The display system of claim 1 further comprising logic to compute a disparity correction based on the secondary image of the right calibration image and the secondary image of the left calibration image, the disparity correction to be used by the one or more microprojectors during subsequent projection of right and left display images, such that each pixel of the right display image and an associated pixel of the left display image are projected with reduced vertical disparity, and with sufficient horizontal disparity to render a stereoscopically fused display locus at a predetermined depth.

4. The display system of claim 3 further comprising:
one or more temperature sensors arranged in the display device; and
logic to cause an increase in a temperature of the display device,
wherein the logic to compute the disparity correction is configured to associate the disparity correction with output of the one or more temperature sensors, for each of a plurality of temperatures of the display device.

5. A stereoscopic, near-eye display device of a self-calibrating display system, the display device comprising:
one or more coupling structures, each being releasably lockable to a complementary coupling structure of a docking unit and configured to prevent movement of the display device relative to the docking unit;
one or more microprojectors configured to project a right calibration image and a left calibration image;
a secondary image receiver configured to receive, from the docking unit, a secondary image of the right calibration image and a secondary image of the left calibration image;
logic to store, in electronic memory of the display device, a disparity correction based on the secondary image of the right calibration image and the secondary image of the left calibration image, the disparity correction to be used by the one or more microprojectors during subsequent projection of right and left display images, such that each pixel of the right display image and an associated pixel of the left display image are projected with reduced vertical disparity, and with sufficient horizontal disparity to render a stereoscopically fused display locus at a predetermined depth; and
logic to retrieve the disparity correction and provide the disparity correction to the one or more microprojectors for the subsequent projection.

6. The display device of claim 5 further comprising:
one or more temperature sensors; and
logic to increase a temperature of the display device,
wherein the logic to store the disparity correction is configured to storably associate the disparity correction with output of the one or more temperature sensors, for each of a plurality of temperatures of the display device.

7. The display device of claim 5 wherein the disparity correction includes a vertical disparity correction and a horizontal disparity correction.

8. The display device of claim 5 wherein the logic to retrieve the disparity correction is configured to interpolate between the stored disparity corrections to compute an interpolated disparity correction.

9. The display device of claim 5 wherein the one or more coupling structures and the one or more complementary coupling structures include a pin and a depression to receive the pin.

10. The display device of claim 5 wherein the one or more coupling structures and the one or more complementary coupling structures include a magnet.

11. The display device of claim 5 wherein the secondary image of the right calibration image and the secondary image of the left calibration image are encoded in data, and wherein the secondary image receiver is a data link configured to receive the data.

12. The display device of claim 5 wherein the secondary image of the right calibration image is an optical reflection of the right calibration image, wherein the secondary image of the left calibration image is an optical reflection of the left calibration image, and wherein the secondary image receiver includes one or more cameras.

13. The display device of claim 5 wherein the one or more microprojectors include separate right and left microprojectors.

14. The display device of claim 5 further comprising an inertial measurement unit and logic to schedule computation of the disparity correction responsive to output from the inertial measurement unit consistent with mechanical shock to the display device.

15. The display device of claim 5 further comprising:
logic to store, in the electronic memory of the display device, a display-image quality correction based on the secondary image of the right calibration image and the secondary image of the left calibration image, the display-image quality correction to be used during the subsequent projection of the right and left display images; and
logic to retrieve the display-image quality correction.

16. A docking unit of a self-calibrating display system, the docking unit comprising:
one or more coupling structures, each being releasably lockable to a complementary coupling structure of a stereoscopic, near-eye display device and configured to prevent movement of the display device relative to the docking unit; and
a secondary image sender configured to send the display device a secondary image of a right calibration image and a secondary image of a left calibration image, the right and left calibration images being received from the display device.

17. The docking unit of claim 16 wherein the secondary image sender includes one or more cameras.

18. The docking unit of claim 16 further comprising an enclosure configured to enclose the display device during transport.

19. The docking unit of claim 16 further comprising a charger configured to charge a battery of the display device.

20. The docking unit of claim 16 further comprising a calibration pattern visible to one or more eye-imaging cameras of the display device when the display device is coupled to the docking unit.
